(19) United States
(12) Patent Application Publication
(10) Pub. No.: US 2021/0313869 A1
(43) Pub. Date: Oct. 7, 2021

(54) PERMANENT-MAGNETIC RADIAL ROTATING JOINT AND MICROPUMP COMPRISING SUCH A RADIAL ROTATING JOINT

(71) Applicant: KARDION GMBH, Stuttgart (DE)

(72) Inventors: Ralf Strasswiemer, Ravenstein (DE); Uwe Vollmer, Sindelfingen (DE)

(21) Appl. No.: 17/055,059

(22) PCT Filed: May 16, 2019
(86) PCT No.: PCT/EP2019/062731

§ 371 Date: Jun. 29, 2021

(30) Foreign Application Priority Data
May 16, 2018 (DE) 10 2018 207 622.7

(51) Int. Cl. H02K 49/10; H02K 1/27

(52) U.S. Cl. CPC H02K 49/106; F04D 13/024; H02K 1/2753

(57) ABSTRACT

The invention relates to a permanent-magnetic radial rotary coupling (100) comprising a first cylindrical permanent magnet (102) and a second hollow-cylindrical permanent magnet (104), wherein the inner diameter of the second permanent magnet (104) is larger than the outer diameter of the first permanent magnet (102). The first permanent magnet (102) and the second permanent magnet (104) are arranged coaxially and mounted such that they can rotate about the common axis (106). Both the first permanent magnet (102) and the second permanent magnet (104) comprise at least one pole pair. The first permanent magnet (102) comprises the same number of pole pairs as the second permanent magnet (104). The first permanent magnet (102) has a radial or a parallel magnetization and the second permanent magnet (104) comprises a Halbach array, the strong side of which is the inner side of the second permanent magnet (104).

The present invention relates to a permanent-magnetic radial rotary coupling and a micropump comprising a permanent-magnetic radial rotary coupling.

Magnetic couplings, in which magnets or pairs of magnets arranged concentrically one inside the other are used to transmit torques without contact, are known in the state of the art. Also known is the use of a diverter element or a special arrangement of magnets to guide the magnetic flux in order to increase the transmittable torque and improve efficiency. Depending on the applied torque, the two coupling parts rotate relative to one another by a few degrees, which statically creates a counter-torque at the level of the externally applied torque.

Increasing the magnetic pole number in order to increase the transmittable torque is known in the state of the art as well. However, particularly in the case of small dimensions, there are limitations due to manufacturability and magnetization. Active magnetic flux guidance by the use of additional elements can also contribute to increasing the torque. In the case of very small dimensions or very limited installation space, however, the difficulty lies in achieving the necessary torque or producing the arrangement and keeping to the available installation space. An arrangement as a Halbach array concentrates the magnetic flux without additional magnetic returns and thus increases the torque, but is technically difficult to produce as a whole or in segments for small dimensions. The Halbach array enables the magnetic flux to be almost cancelled out on one side of the arrangement, but increased on the other side (strong side). To shield the magnetic field then, either the components arranged to guide the magnetic flux or, if necessary, further passive components are added, which likewise take up space and can cause design problems.

The fact that a Halbach array can make the magnetic flux almost disappear on one side of the arrangement and amplify it on the other side can be illustrated using a specific embodiment of a Halbach array. To do this, one imagines an arrangement of regions having different magnetization along the surface, for example from left to right. On the far left, in a first position, the arrangement has a downward directed magnetization; further right, in a third position, the magnetization is directed upward; and even further right, in a fifth position, the magnetization is again directed downward. The magnetic field of this arrangement extends from the third position upward, along an arc, to the first and fifth position. From the first and fifth position, the magnetic field extends downward, along a respective arc, to the third position. It can therefore be seen that the magnetic field describes two circles, whereby the left circle is traversed in counterclockwise direction and the right circle in clockwise direction.

However, the arrangement has further magnetizations at a second position, which is between the first and third position, and at a fourth position, which is between the third and fifth position. At the second position the magnetization is directed to the right, i.e. it points from the first to the third position, and at the fourth position the magnetization is directed from right to left, i.e. it points from the fifth to the third position. The magnetic field of the arrangement of the second and fourth position can likewise be described by two circles, whereby the field lines in the left circle extend from the third position upward to the first position and also downward to the first position. The field lines in the right circle extend from the third position upward to the fifth position and also downward to the fifth position. In the case of the two circles of the arrangement of the second and fourth position, the circles are therefore not traversed in clockwise or counterclockwise direction. Rather, the left circle is traversed counterclockwise from the 3 o'clock position, i.e. from the third position, through the 12 o'clock position to the 9 o'clock position and clockwise from the 3 o'clock position through the 6 o'clock position to the 9 o'clock position.

The right circle is traversed clockwise from the 9 o'clock position, i.e. from the third position, through the 12 o'clock position to the 3 o'clock position and counterclockwise from the 9 o'clock position through the 6 o'clock position to the 3 o'clock position.

The effective field of all five positions is a superpositioning of the first, third and fifth position on the one hand and the second and fourth position on the other hand. The effective field thus results as a superpositioning of the two above-described circles of the first, third and fifth position and the two above-described circles of the second and fourth position. It can be seen that, on the top of the arrangement, i.e. between the 9 o'clock position through the 12 o'clock position to the 3 o'clock position, the field lines are amplified, and below the arrangement, i.e. between the 9 o'clock position through the 6 o'clock position to the 3 o'clock position, the field lines almost cancel out. This is because the field lines coming from the first, third and fifth position and the field lines coming from the second and fourth position are parallel above the arrangement and antiparallel below the arrangement.

Based on this, the underlying object of the invention is to further improve the couplings and micropumps equipped with such couplings known in the state of the art in terms of efficient torque transmission and compact design.

To achieve this object, the combination of features specified in the independent claims is proposed. Advantageous configurations and further developments of the invention emerge from the dependent claims.

The permanent-magnetic radial rotary coupling is used for the contactless transmission of torques. For this purpose, magnets arranged concentrically one inside the other are used. The radial rotary coupling can alternatively also be referred to as a central rotary coupling.

The permanent-magnetic radial rotary coupling comprises a first cylindrical permanent magnet and a second hollow-cylindrical permanent magnet.

The inner diameter of the second permanent magnet is larger than the outer diameter of the first permanent magnet. The first permanent magnet and the second permanent magnet are also arranged coaxially, so that the first permanent magnet is disposed inside the second permanent magnet. The first permanent magnet and the second permanent magnet are furthermore both mounted such that they can rotate about the common axis.

In addition, both the first permanent magnet and the second permanent magnet comprise at least one pole pair, whereby the first permanent magnet comprises the same number of pole pairs as the second permanent magnet.

The first permanent magnet further has a radial or a parallel magnetization and the second permanent magnet comprises a Halbach array, the strong side of which is the inner side of the second permanent magnet. The torque can consequently be increased, because the magnetic flux is guided more effectively as a result of the arrangement and magnetization of the two permanent magnets. This leads to a reduction of the required total volume and thus to a reduction of the magnet volume, or enables the same magnetic flux with the same magnet volume, without additional design measures that would be necessary according to the state of the art, e.g. the attachment of a magnetic return device. This special arrangement makes it possible to achieve very small dimensions that, using conventional arrangements, can only be achieved with a lower torque. For ventricular heart support pumps, for example, very small dimensions, for example a 6 mm coupling outer diameter and an overall length of 5 mm, can be realized. At the same time, the production-related disadvantages of a coupling designed with two concentric Halbach arrays can be avoided. Magnet parts with an outer diameter of the inner magnet ring of 3 mm, for example, and a respective segmentation of 45° are hardly feasible. The abovementioned arrangement makes it possible to achieve very small dimensions for miniature axial pumps in general and particularly in the medical field, which can transmit high torques despite the small dimensions.

The term “parallel magnetization” is also referred to as diametrical magnetization, in which the magnetization extends parallel to the diameter. In the case of radial magnetization, the magnet is magnetized along the radius, i.e. radially.

According to a preferred embodiment, an outer diameter of the second permanent magnet is less than 6 mm. This makes it possible for heart pumps or heart support systems (VAD: ventricular assist device) to advantageously be manufactured with extremely small dimensions.

According to another preferred embodiment, the Halbach array of the second permanent magnet comprises segments. The Halbach array of the second permanent magnet in particular consists of segments or is configured in segments. The advantage of this design is that a Halbach array can be formed by simply putting the segments together.

According to a preferred embodiment, the first permanent magnet is hollow-cylindrical. It is further preferred that a shaft is disposed inside the first permanent magnet. The advantage of this design is that a driving shaft can be coupled to the first permanent magnet and that the torque of the driving shaft can be transmitted to the second permanent magnet. A torque can alternatively also be transmitted from the second permanent magnet to the first permanent magnet. According to another preferred embodiment, a further shaft is connected or coupled to the second permanent magnet.

According to a preferred embodiment, an axial length of the first permanent magnet is equal to an axial length of the second permanent magnet. The advantage of this design is that the two permanent magnets form a compact unit. Furthermore, if the two permanent magnets are flush with one another, it can advantageously be ensured that no axial forces act on the two permanent magnets.

According to a preferred embodiment, an axial length of the first permanent magnet is not equal to an axial length of the second permanent magnet. The design of the permanent-magnetic radial rotary coupling can therefore advantageously be more free. Thus, for example, a driving shaft can be connected to a first permanent magnet and an output shaft can be connected to the second permanent magnet, whereby both permanent magnets are axially offset, which produces an axial force between both permanent magnets.

According to a preferred embodiment, the first permanent magnet and the second permanent magnet are axially offset. The advantage of this design is that an axial force can be adjusted.

According to a preferred embodiment, a device for magnetic return is disposed on the outside of the second permanent magnet. To shield the leakage fluxes, the magnetic return is preferably mounted concentrically on the outside of the Halbach array. In addition to advantages in terms of production technology, this has the advantage that the torque of the coupling is increased, because fewer stray fields are lost.

Higher pole pair numbers can also be realized for blood pumps having a small diameter, i.e. approx. 6 to 8 mm. Due to the small size of the magnet segments, however, a maximum pole number of four, i.e. a pole pair number of two, is realistic for axial blood pumps. Both submersible pumps and radial blood pumps generally have a larger coupling diameter, which is why, in this case, higher pole numbers are possible.

The micropump comprises a permanent-magnetic radial rotary coupling as is described above. This advantageously provides a micropump which has the benefits of the aforementioned radial rotary coupling.

The permanent-magnetic radial rotary coupling can be used in a wide variety of miniature pumps, e.g. blood pumps, ventricular heart support pumps, in miniature axial pumps in general and in particular in the medical field, furthermore in drives or tools of all kinds, and most importantly in dosing or micropumps for driving impeller-shaped rotors.

According to a preferred embodiment, an outer diameter of the micropump is less than 10 mm, particularly preferably less than 8 mm and even more preferably less than 6 mm. This advantageously provides a micropump having extremely small dimensions.

Design examples of the invention are shown in the drawings and are explained in more detail in the following description.

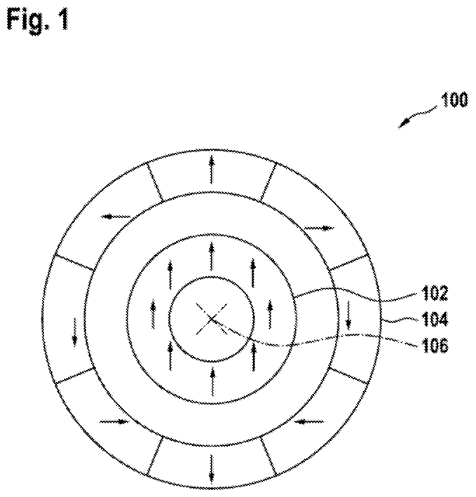

FIG. 1 shows a radial section of a permanent-magnetic radial rotary coupling according to a design example of the invention.

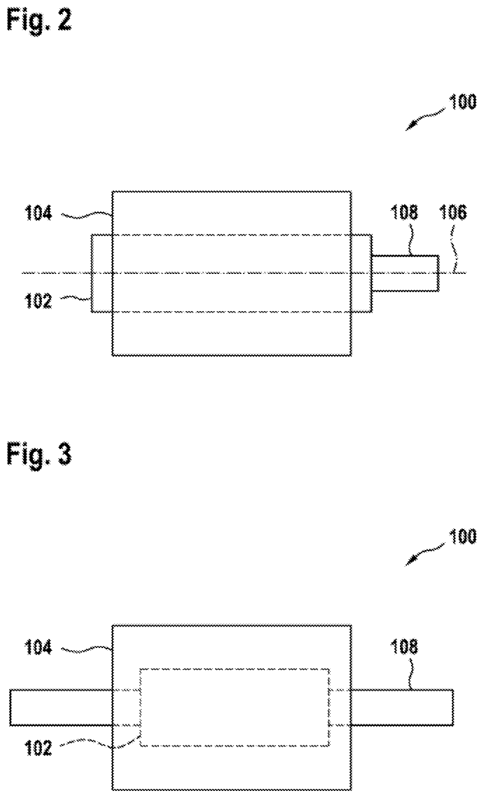

FIGS. 2 and 3 show side views according to two design examples of the invention.

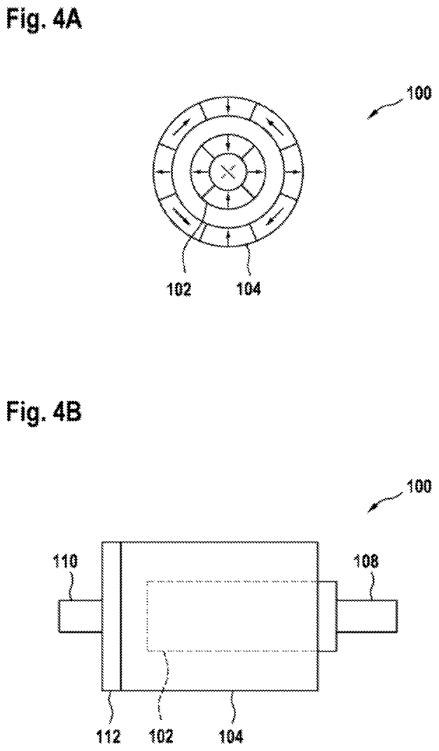

FIG. 4A shows a radial sectional view of an embodiment of a permanent-magnetic radial rotary coupling according to a design example of the invention.

FIG. 4B shows a side view according to the embodiment of FIG. 4A.

FIG. 1 shows a sectional view of the permanent-magnetic radial rotary coupling transverse to the axis of rotation according to a design example of the invention. FIG. 1 shows a permanent-magnetic radial rotary coupling 100, which comprises a first permanent magnet 102 and a second permanent magnet 104. Both the first permanent magnet 102 and the second permanent magnet 104 are hollow-cylindrical. A driving shaft can be disposed inside the first permanent magnet 102.

The inner diameter of the second permanent magnet 104 is larger than the outer diameter of the first permanent magnet 102. The first permanent magnet 102 and the second permanent magnet 104 are furthermore arranged coaxially. Both the first permanent magnet 102 and the second permanent magnet 104 are mounted such that they can rotate about the common axis 106.

The first permanent magnet 102 is magnetized in parallel and comprises one pole pair. In the case of a cylinder or hollow cylinder, as in the case of the first permanent magnet 102, one can also speak of diametrical magnetization.

The second permanent magnet 104 likewise comprises one pole pair. The second permanent magnet 104 is furthermore realized as a Halbach array, the strong side of which is the inner side of the second permanent magnet 104.

The second permanent magnet 104 comprises eight 45° segments in the outer ring, while the first permanent magnet 102 consists of only a single component. This is one reason why the first permanent magnet 102 can be made so small.

FIG. 2 shows a side view of the permanent-magnetic radial rotary coupling 100 of the embodiment of FIG. 1. It can be seen here that the axial extension of the first permanent magnet 102 is greater than the axial extension of the second permanent magnet 104. It can further be seen that the first permanent magnet 102 is connected on one side to a driving shaft 108.

FIG. 3 shows a side view of a permanent-magnetic radial rotary coupling 100 according to a further embodiment. It can be seen here that the axial extension of the first permanent magnet 102 is smaller than the axial extension of the second permanent magnet 104, whereby both axial ends of the first permanent magnet 102 are located inside the second permanent magnet 104. It can further be seen that the first permanent magnet 102 is connected on both sides to a driving shaft 108.

FIG. 4A shows a sectional view of an embodiment of a permanent-magnetic radial rotary coupling according to a design example of the invention.

FIG. 4A shows a permanent-magnetic radial rotary coupling 100, which likewise comprises a first permanent magnet 102 and a second permanent magnet 104 as in the embodiment of FIG. 1.

In contrast to the embodiment of FIG. 1, however, according to the embodiment of FIG. 4A, both the first permanent magnet 102 and the second permanent magnet 104 respectively comprise two pole pairs. The inner first permanent magnet 102 comprises four 90° segments in radial magnetization, while the outer second permanent magnet 104 comprises eight 45° segments as a Halbach array.

FIG. 4B shows a side view of the embodiment of FIG. 4A. It can be seen here that the inner first permanent magnet 102 is connected on one side to a driving shaft 108, while the outer second permanent magnet 104 is connected on the other side to an output shaft 110 by means of an axial connecting ring 112. The inner first permanent magnet 102 is furthermore axially offset relative to the outer second permanent magnet 104 in order to produce an axial force.

For a coupling in a blood pump, for example, the first permanent magnet has the following dimensions: an inner diameter of 1 mm, an outer diameter of 3 mm and a magnet thickness of 1 mm. For the same example of a coupling in a blood pump, the second permanent magnet has the following dimensions: an inner diameter of 4 mm, an outer diameter of 5 mm and a magnet thickness of 0.5 mm.

1. A permanent-magnetic radial rotary coupling for use in a micropump to facilitate fluid flow within a heart, the permanent-magnetic radial rotary coupling comprising:
a first cylindrical permanent magnet being mounted such that the first cylindrical permanent magnet is configured to rotate about a common axis, the first cylindrical permanent magnet comprising:
an outer diameter;
a first amount of pole pairs; and
a magnetization being radial or parallel;
a second hollow-cylindrical permanent magnet being arranged coaxially relative to the first cylindrical permanent magnet and being mounted such that the second hollow-cylindrical permanent magnet is configured to rotate about the common axis, the second hollow-cylindrical permanent magnet comprising:
an inner diameter being larger than the outer diameter of the first permanent magnet;
a second amount of pole pairs, the second amount being equal to the first amount of pole pairs; and
a Halbach array comprising a strong side, the strong side being located on an inner side of the second hollow-cylindrical permanent magnet.

2. The permanent-magnetic radial rotary coupling of claim 1, wherein an outer diameter of the second hollow-cylindrical permanent magnet is less than 10 mm.

3. The permanent-magnetic radial rotary coupling of claim 1, wherein the Halbach array of the second hollow-cylindrical permanent magnet has segments.

4. The permanent-magnetic radial rotary coupling of claim 1, wherein the first permanent magnet is a hollow-cylinder.

5. The permanent-magnetic radial rotary coupling of claim 1, further comprising a shaft being disposed inside the first permanent magnet.

6. The permanent-magnetic radial rotary coupling of claim 1, wherein an axial length of the first permanent magnet is equal to an axial length of the second hollow-cylindrical permanent magnet.

7. The permanent-magnetic radial rotary coupling of claim 1, further comprising a device for magnetic return being disposed on an outside of the second hollow-cylindrical permanent magnet.

8. A micropump to facilitate fluid flow within a heart, the micropump comprising:
a first cylindrical permanent magnet being mounted such that the first cylindrical permanent magnet is configured to rotate about a common axis, the first cylindrical permanent magnet comprising:
an outer diameter;
a first amount of pole pairs; and
a magnetization being radial or parallel;
a second hollow-cylindrical permanent magnet being arranged coaxially relative to the first cylindrical permanent magnet and being mounted such that the second hollow-cylindrical permanent magnet is configured to rotate about the common axis, the second hollow-cylindrical permanent magnet comprising:
an inner diameter being larger than the outer diameter of the first permanent magnet;
a second amount of pole pairs, the second amount being equal to the first amount of pole pairs; and
a Halbach array comprising a strong side, the strong side being located on an inner side of the second hollow-cylindrical permanent magnet.

9. The micropump of claim 8, wherein an outer diameter of the micropump is less than 10 mm.

10. The micropump of claim 9, wherein the outer diameter of the micropump is less than 8 mm.

11. The micropump of claim 8, wherein an axial length of the first permanent magnet is different than an axial length of the second hollow-cylindrical permanent magnet.

12. The micropump of claim 8, wherein the first permanent magnet is positioned longitudinally offset in an axial direction relative to the second hollow-cylindrical permanent magnet.

13. The micropump of claim 12, wherein the axial direction is in a direction away from the second hollow-cylindrical permanent magnet.

14. The micropump of claim 8, further comprising:
a driving shaft connected to the first permanent magnet; and
an output shaft connected to the second hollow-cylindrical permanent magnet.

15. The micropump of claim 1, wherein the micropump is configured for driving an impeller-shaped rotor.

16. The permanent-magnetic radial rotary coupling of claim 2, wherein an outer diameter of the micropump is less than 10 mm.

17. The permanent-magnetic radial rotary coupling of claim 1, wherein an axial length of the first permanent magnet is different than an axial length of the second hollow-cylindrical permanent magnet.

18. The permanent-magnetic radial rotary coupling of claim 1, wherein the first permanent magnet is positioned longitudinally offset in an axial direction relative to the second hollow-cylindrical permanent magnet.

19. The permanent-magnetic radial rotary coupling of claim 18, wherein the axial direction is in a direction away from the second hollow-cylindrical permanent magnet.

20. The permanent-magnetic radial rotary coupling of claim 1, wherein an axial length of the permanent-magnetic radial rotary coupling is 5 mm.

21. The permanent-magnetic radial rotary coupling of claim 1, further comprising:
a driving shaft connected to the first permanent magnet; and
an output shaft connected to the second hollow-cylindrical permanent magnet.

22. The permanent-magnetic radial rotary coupling of claim 1, wherein the permanent-magnetic radial rotary coupling is configured for use in a micropump for driving an impeller-shaped rotor.
